(19) United States
(12) Patent Application Publication
(10) Pub. No.: US 2023/0242421 A1
(43) Pub. Date: Aug. 3, 2023

(54) METHOD AND SYSTEM FOR ENHANCING AND RETAINING GROWTH AND HEALTH OF BIOMATTER

(71) Applicant: Hyo Technologies, Inc., Raleigh, NC (US)

(72) Inventor: Robert Dubose, New Port Richey, FL (US)

(21) Appl. No.: 18/295,753

(22) Filed: Apr. 4, 2023

Related U.S. Application Data
(63) Continuation-in-part of application No. 16/922,960, filed on Jul. 7, 2020, now Pat. No. 11,647,706.
(60) Provisional application No. 62/906,994, filed on Sep. 27, 2019.

(51) Int. Cl. C02F 1/461; C02F 1/72

(52) U.S. Cl. CPC C02F 1/461; C02F 1/72; C02F 2307/14

(57) ABSTRACT

A method and system for use therein for providing O₂ and H₂ gases directly to the soil proximal to the roots of plants, to harvested produce of plants, and to animals drinking supply via electrolysis is described. The method employs at least one electrolyzer disposed adjacent to, or inline with, the irrigation waterline of the plant grow operation or to the water supply waterline of the animals to facilitate the introduction of the gases to the soil or animals. A power source is used to provide the electrolytic conversion, and gases remain in a micro-bubbled form to flow through the waterline more easily to the plants where they are needed the most. A venturi may be used to channel the dissolved gases in the waterline from the electrolyzer in embodiments having an external unit. The preferred inline embodiment electrolyzes the water without need of a venturi to reintroduce the gases to the waterline.

### CONTINUITY

This application is a continuation-in-part of non-provisional patent application Ser. No. 16/922,960, filed on Jul. 7, 2020, and of provisional application No. 62/906,994, filed on Sep. 27, 2019, and priority is claimed thereto.

### FIELD OF THE PRESENT INVENTION

The present invention relates to methods for enhancing stamina, health, growth and yield in plants, as well as to enhance the preservation of post-harvest plants, produce, meats and other biomatter by soaking or spraying them with hydrogen-rich water. Further, the present invention relates to enhancing the growth of bio-matter in general, including livestock, poultry, and fish. Additionally, the present invention relates to soaking in hydrogen rich water to improve health, healing and wellness in a pond, pool or spa. In particular, the present invention relates to methods for enhancing growth and yield by exposing plant roots, harvested produce, and/or other biologically farmed organisms to hydrogen and/or oxygen gases (H₂+O₂), via a waterline as produced via electrolysis, where H₂ and/or O₂ is bubbled or dissolved into the water line while being delivered to the plant root rhizosphere in the soil, or to the animal via hydration, or by soaking in a pond, pool or spa. Broadly, the present invention is a method for enhancing and retaining growth or yield by exposing roots to H₂ gas and/or O₂ gas, and growing plants in soil, hydroponics or aeroponics.

### BACKGROUND OF THE PRESENT INVENTION

Farmers and scientists have long understood that oxygenated soils improve plant respiration, mineral uptake, and water movement in roots, all of which have a positive impact on plant growth and productivity. More recently, researchers discovered that hydrogen also plays a significant role in plant health and stamina. The successful delivery of nitrogen to plant roots is highly dependent upon soil conditions, environmental conditions, and the type of fertilizer. Healthy soil bacteria are essential for the conversion of traditional fertilizers into useable nitrogen for plants. Farmers utilize legumes, which produce hydrogen as a byproduct of N₂ fixation, to regenerate soil after a season or two of growing high demand crops. Scientific studies suggest hydrogen could be the missing ingredient required to ensure a healthy and thriving soil ecosystem.

Hydrogen and oxygen can best assist in the growth of plants when it is exposed to the roots of the plant. If there were a way in which oxygen and hydrogen could be introduced to the plants in a focused and controlled manner, on demand, to the locations needing it most, namely, the roots, the growth of the plants would be enhanced.

Conventionally, tilling of the soil is preferably performed in order to introduce oxygen into the soil. However, tilling is known to cause issues to proximal land and nearby water systems due to runoff. Some jurisdictions limit the frequency of tilling, and others have regulations in place which fine individuals found to be tilling more frequently than the allotment stated in the regulations. If there were a way in which tilling could be further reduced or eliminated, fewer fines would be imposed, and the health of the land and proximal bodies of water could be preserved.

Thus, there is a need for a new plant growth enhancing method and system configured to expedite and facilitate the growth of plants via the careful and deliberate introduction of specific gases to the soil, substrate, and/or irrigation system of the grow operation. Electrolysis equipment is preferably disposed directly inside of (or inline with) the water line to facilitate introduction of the desired gases to the grow operation to enable the method of the preferred embodiment of the present invention.

### SUMMARY OF THE PRESENT INVENTION

The present invention is a plant growth enhancement system and apparatus configured to facilitate and expedite the growth of plants grown in a controlled environment. The system employs integrated electrolysis equipment disposed within the water line itself of the irrigation system of the grow operation to enable to seamless introduction of the desired gases, namely hydrogen and oxygen, to the plants to stimulate growth.

It is an object of the present invention to provide a method for enhancing plant stamina, health growth and yield by exposing soil to hydrogen and or oxygen gases (H₂ and/or H₂+O₂). It is envisioned that by increasing the amount of gases delivered to the soil before seeding, flowering/budding, the growth rate could be accelerated, along with an overall better health and stamina of the plants being observed. This object is similarly applicable to post-harvest produce, enabling the yield to remain fresh longer.

Further, the present invention includes a method by which the growth, health, and stamina of livestock, poultry, and fish is enhanced via water which has been exposed to electrolysis.

Further, the present invention includes a method by which animals, mammals and humans alike can experience increased health and wellness by soaking in the hydrogen rich water created via electrolysis.

The following brief and detailed descriptions of the drawings are to provide the embodiment of the present invention but is not provided to limit the scope of the present invention as expressed herein this summary section.

### BRIEF DESCRIPTION OF THE DRAWING

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 depicts a view of the primary embodiment of the method system of the present invention shown as a flow chart diagram.

FIG. 2 depicts a view of the second embodiment of the method and system of the present invention, employing a venturi entry system, shown as a flow chart diagram.

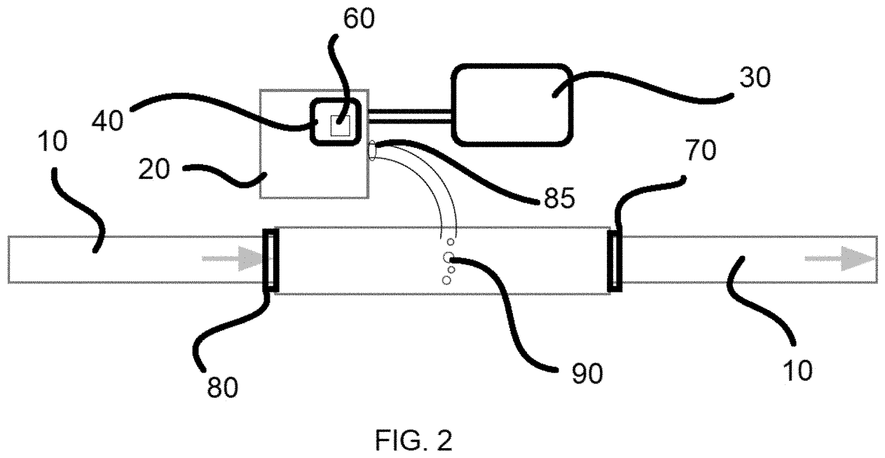

FIG. 3 shows a flow chart detailing the method and system of the present invention in operation.

FIG. 4 shows a front view of an embodiment of the apparatus employed in the method of the present invention, exhibiting an electrolyzer.

### DETAILED DESCRIPTION OF THE PREFERRED EMBODIMENT

The present specification discloses one or more embodiments that incorporate the features of the invention. The disclosed embodiment(s) merely exemplify the invention. The scope of the invention is not limited to the disclosed embodiment(s).

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment, Further, when a particular feature, structure, or characteristic is described in connection with an embodiment, it is submitted that it is within the knowledge of one skilled in the art to effect such feature, structure, or characteristic in connection with other embodiments whether or not explicitly described.

The present invention is a method of enhancing the growth of plants within a controlled growth environment. The method employs an irrigation water line (10) of an existing irrigation system of the grow operation to facilitate the introduction of hydrogen and/or oxygen to the plants of the grow operation which are produced via electrolysis. As such, the present invention is configured to introduce these plant growth-enhancing gases where they are needed most, at the roots of the plant, to stimulate growth.

The system preferably includes two methods of achieving the desired outcome of enhanced plant growth: a first method detailing the use of an in-line unit (20), and a second method configured to employ a venturi to facilitate the introduction of the desired gases to the water line (10) of the irrigation system of the grow operation from a nearby external unit (20). In each method, a power source (30) is employed to power a hydrogen and/or oxygen processor (40) disposed within the unit (20).

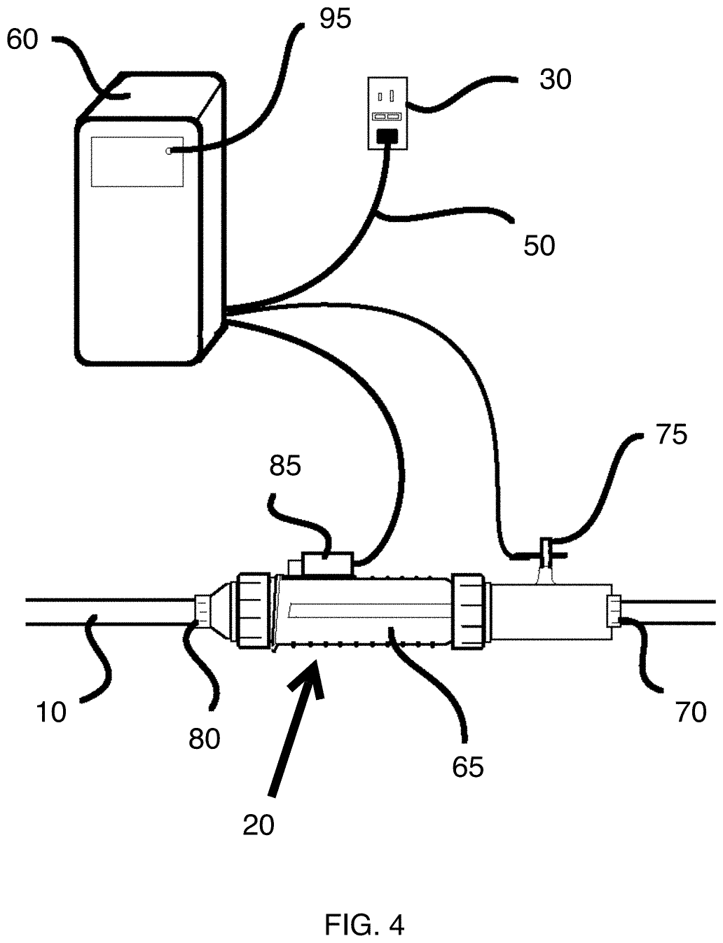

As depicted in the preferred embodiment shown in FIG. 4, power is conveyed from the power source (30) to the hydrogen and/or oxygen generator via at least one wire (50). A hydrogen cell (65), as shown in FIG. 4, is routed inline with the waterline (10) to hydrogenate the water. A control valve (75) present behind the hydrogen cell (65) enables a user to stop the flow of water as desired. The hydrogen cell (65) is connected to the electrolyzer (60) via a connector (85). An LED light (95) on the electrolyzer (60) illuminates when hydrogen is being produced.

The primary difference between the two methods is the means by which the gases are introduced to the water line (10). The mechanics of the unit (20) itself remains consistent in both methods, however the means of introduction of the gases varies. In both cases, an electrolyzer (60) disposed within the unit (20) employs electricity from the power source (30) to split water, coming from the water line (10) of the irrigation system of the grow operation, into hydrogen and oxygen in gaseous form respectively.

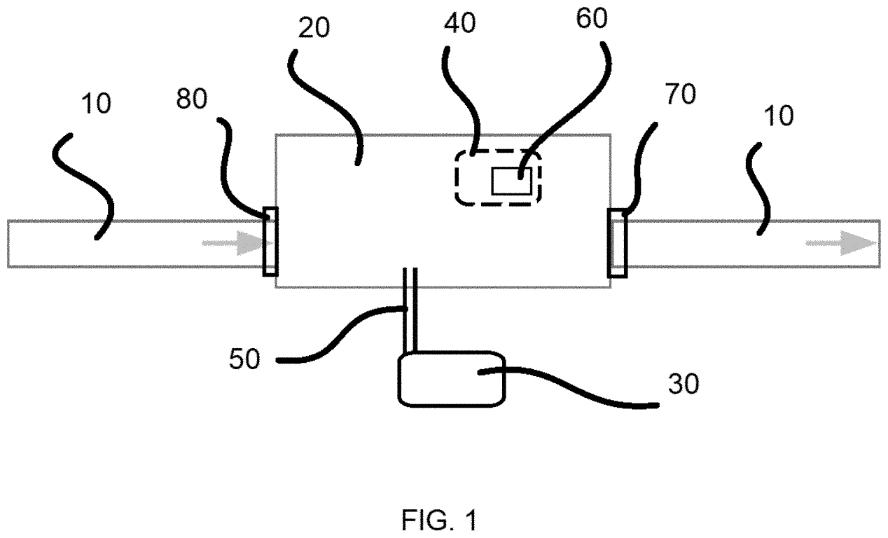

Hydrogen and oxygen produced via the electrolyzer (60) are present in the form of micro-bubbles (90) which are then micro-bubbled or dissolved in the water line (10) as it exits an output (70) of the unit (20). Dissolution of the micro-bubbles (90) ensures that the gases effectively disappear into the water column, reducing possible percentage loss as the gases exit the waterline and allowing more of the beneficial gases to get to the roots of the plants. Alternately, in the second method, the micro-bubbles of hydrogen and oxygen are effectively dissolved and introduced back to the water line (10) via a venturi facilitated via a coupling (85) disposed on a side of the unit (20) as shown in FIG. 1.

It should be understood that the technology is scalable to size, depending on the waterline diameter and gallons-per-minute (GPM) of waterflow. The electrolyte in the elecrolyzer of the unit (20) of the present invention may vary; however, it is envisioned that the second method which uses the venturi-based system employs NAOH or KOH electrolytes. Conversely, the first method which uses the inline system is preferably configured to use only electrolytes derived from the minerals present in the irrigation water itself, or by amendments added to the waterline itself prior to entering the electrolyzer.

Insulation is not ideally needed because the system used in the method of the present invention is preferably shut down and drained during winter months. The venturi method requires routine maintenance and is easily accessible. The inline method of use of the unit (20) in the method of the present invention preferably requires no maintenance. The venturi system employed in the method of the present invention has its own, self-contained, cooling methodology. In contrast, the inline system stays cool during operation because the water is constantly flowing through it, cooling the electrolyzer (60) within the unit (20) continuously. It should be noted that the unit (20) is equipped with an input (80) and an output (70) per convention.

It should be understood that the method of execution, as well as the hardware employed in the method, is consistent for hydroponic or aeroponic grow operations as well conventional soil substrate grow operations.

As previously indicated, the methods of the present invention enable the introduction of H₂, O₂, or both gases to the water via the irrigation waterline. The venturi method allows for the separation of the gases, where either could be vented off within the unit (20) prior to introduction of the gas to the waterline via the venturi. In contrast, the inline method using the inline unit (20) delivers only both gases simultaneously, and therefore does not enable one to select what gas or how much is provided to the waterline.

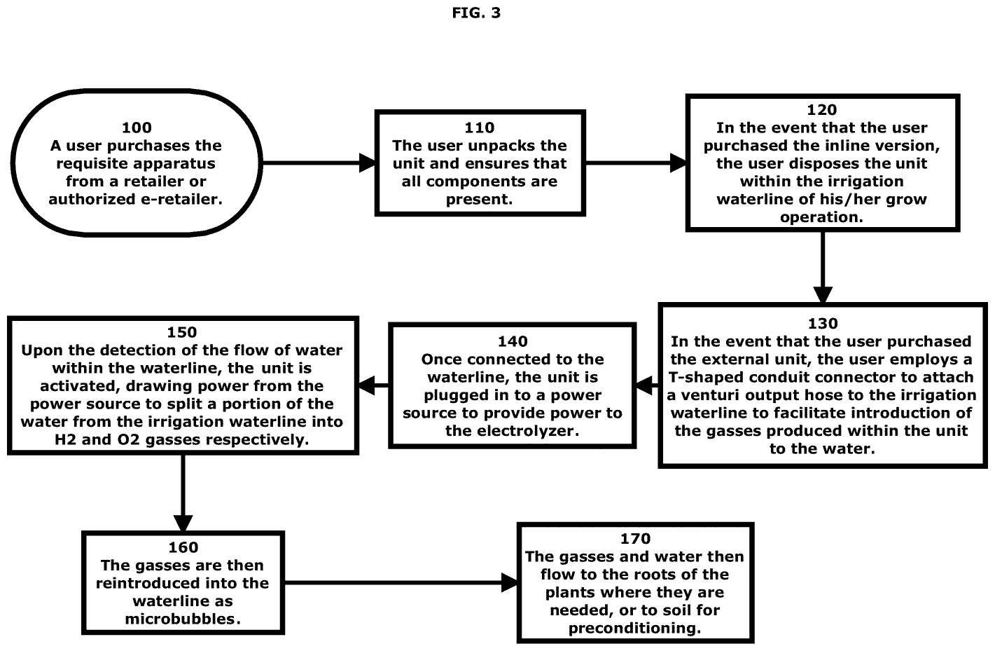

The process of installation and use of the inline embodiment of the system and apparatus of the present invention, as shown in FIG. 3, is preferably as follows:
1. A user purchases the requisite apparatus from a retailer or authorized e-retailer. (100)
2. The user unpacks the unit and ensures all components are present. (110)
3. The user disposes the unit within the irrigation waterline of their grow operation. (120) This may be accomplished by cutting the irrigation line and installing the inline electrolyzer component through attaching the now two separated lines to the input and output ends of the inline unit and ensuring the lines are firmly affixed to the input and output sides of the unit.
4. Once connected to the waterline, the unit is plugged in to a power source to provide power to the electrolyzer. (130)
5. Upon the detection of the flow of water within the waterline, the unit is activated, drawing power from the power source to split a portion of the water from the irrigation waterline into H₂ and O₂ gases respectively. (140)
6. The gases and water then flow to the roots of the plants where they are needed, or to soil for preconditioning. (150)

It should be noted that the process of adding more H₂ or H₂ and O₂ to the soil is preferably in excess of 50 times more than what is presently found in the atmosphere on average. Additionally, it may be advantageous to add H₂ or H₂ and O₂ to the soil during the off-season months in order to ‘bank’ the gases into the soil for the subsequent season's grow operation in order to help to increase the growth and yield. By either increasing the electrical input from the power source (30) or by reducing the gallons per minute of the waterflow of the waterline, more H₂ or H₂ and O₂ could be deliver to the target crop as a percentage of overall irrigation.

As previously noted, the method and process of the present invention is similarly applicable to post-harvest yields, including produce, sod, hemp, or similar products. In such instances, the water which has been exposed to electrolysis, and therefore is enhanced with hydrogen and oxygen, is exposed to the post-harvest yield. After the exposure, especially when prolonged, the harvest is known to retain freshness longer than a control group not exposed to water having undergone electrolysis.

Similarly, as previously noted, the method and process of the present invention is also effective at enhancing the development and growth of animals, including, but not limited to livestock, poultry, and fish after prolonged exposure. Exposing the animals to water treated via the process and method of the present invention via hydration is shown to encourage, enhance, and maintain healthy growth of the animal. Exposure to hydrogen enriched water in a pond, pool or spa increase the health and wellness of animals, fish and humans alike. In such instances of use of the method of the present invention, the treated waterline is configured to flow to water troughs or bowls from which the animals consume water. For fish, the water treated via the method of the present invention is directed to the pond, aquaculture, fish farm, or similar small body of water, enhancing and maintaining healthy growth of the fish.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A method of delivering hydrogen to plants to enhance their growth comprising:
disposing a unit in communication with a water supply;
wherein the unit contains an electrolyzer, a waterline input, and a waterline output;
connecting the electrolyzer of the unit to a power supply;
initiating the flow of water within a waterline, the passage of water activating the electrolyzer of the unit;
the water supply providing the flow of water to the waterline;
the electrolyzer converting water of the waterline into oxygen and hydrogen, wherein the electrolyzer splits water, coming from the waterline of the irrigation water supply;
the unit channeling dissolved microbubbles of hydrogen and oxygen back into the water of the waterline; and
the water saturated with the dissolved microbubbles exiting the unit via the waterline output.

2. The method of claim 1, further comprising:
exposing the soil of the plants to the microbubbles, banking oxygen into the soil.

3. The method of claim 1, further comprising:
exposing the soil of the plants to the microbubbles, banking hydrogen into the soil.

4. The method of claim 2, further comprising:
exposing the soil of the plants to the microbubbles, banking hydrogen into the soil.

5. The method of claim 1, further comprising: the plants absorbing the water, exposing them to the microbubbles, enhancing plant growth.

6. The method of claim 2, further comprising: the plants absorbing the water, exposing them to the microbubbles, enhancing plant growth.

7. The method of claim 1, wherein the entirety of the waterline flows through the electrolyzer.

8. The method of claim 2, wherein the entirety of the waterline flows through the electrolyzer.

9. The method of claim 3, wherein the entirety of the waterline flows through the electrolyzer.

10. The method of claim 4, wherein the entirety of the waterline flows through the electrolyzer.

11. The method of claim 6, wherein the entirety of the waterline flows through the electrolyzer.

12. The method of claim 1, further comprising:
exposing the soil of the plants to the microbubbles, banking hydrogen and oxygen into the soil.

13. The method of claim 12, wherein the entirety of the waterline flows through the electrolyzer.

14. A method of enhancing growth in livestock, poultry and fish comprising:
disposing a unit in communication with a water supply;
wherein the unit contains an electrolyzer, a waterline input, and a waterline output;
connecting the electrolyzer of the unit to a power supply;
initiating the flow of water within a waterline, the passage of water activating the electrolyzer of the unit;
the water supply providing the flow of water to the waterline;
the electrolyzer converting water of the waterline into oxygen and hydrogen, wherein the electrolyzer splits water, coming from the waterline of the irrigation water supply;
the unit channeling dissolved microbubbles of hydrogen and oxygen back into the water of the waterline; and
the water saturated with the dissolved microbubbles exiting the unit via the waterline output.

15. The method of claim 14, wherein the waterline output flows to at least one of the following for the enhancement of the growth of fish: a fish farm, an aquaculture, a pond, a lake, a fish tank, or a pool.

16. The method of claim 14, wherein the waterline output flows to at least one of the following for the enhancement of the growth of poultry: a watering dish, a water dispenser, a water bowl, a water bottle, or a trickle feeder.

17. The method of claim 14, wherein the waterline output flows to at least one of the following for the enhancement of the growth of livestock: a water trough, or a water bowl.

18. A method of maintaining the freshness of post-harvest produce and/or product comprising:
disposing a unit in communication with a water supply;
wherein the unit contains an electrolyzer, a waterline input, and a waterline output;
connecting the electrolyzer of the unit to a power supply;
initiating the flow of water within a waterline, the passage of water activating the electrolyzer of the unit;
the water supply providing the flow of water to the waterline;
the electrolyzer converting water of the waterline into oxygen and hydrogen, wherein the electrolyzer splits water, coming from the waterline of the irrigation water supply;
the unit channeling dissolved microbubbles of hydrogen and oxygen back into the water of the waterline; and [symbol]
